(19) United States
(12) Patent Application Publication
(10) Pub. No.: US 2006/0042469 A1
(43) Pub. Date: Mar. 2, 2006

(54) Mass air engine management systems for vintage style automobile engines

(76) Inventor: Christopher H. Richards, West Brookfield, MA (US)

Correspondence Address: JAMES F. BAIRD, Esq., 33 East Main Street, POBox 574, West Brookfield, MA, 01585-0574, US

(21) Appl. No.: 11/175,718

(22) Filed: Jul. 6, 2005

Related U.S. Application Data
(60) Provisional application No. 60/605,693, filed on Aug. 31, 2004.

(51) Int. Cl. B01D 46/00

(52) U.S. Cl. 96/422

(57) ABSTRACT

Mass Air Engine Management Systems For Vintage Style Automobile Engines that uses a Mass Air Flow Sensor positioned above a vertically mounted throttle body and below a traditional vintage style air filter assembly. The Mass Air Flow Sensor may be positioned inside the air filter assembly, as an integral part of the air filter assembly or as an integral part of the vertically mounted throttle body. The result is a vintage appearance.

### CROSS REFERENCE

This Application is the formal application for Provisional Application No. 60/605,693, filed Aug. 31, 2004.CR 1 of 1

### FIELD OF INVENTION

The present invention relates generally to the use of modern mass air engine management systems in vintage automobile engines, and modern automobile engines desiring a vintage look.

### BACKGROUND OF THE INVENTION

As the popularity of the restoration of vintage style automobiles increases, and the number of authentic replica vehicles increases, so does the need for design and componentry to incorporate today's modern engine technologies while maintaining a “vintage” engine look. Use of Modern programmable speed density engine management systems is a known technique used to enhance the performance of vintage engines or to maintain modern system performance while maintaining a vintage engine look. For example, a modern technology speed density sensor such as MAP sensor or manifold air pressure sensor can be incorporated into a vintage style speed density system by mounting the sensor in the engine compartment and connecting it to the intake manifold by means of a vacuum hose. This technique for obtaining modern fuel injection system performance in vintage automobiles or replicas of vintage automobiles is common process knowledge.

A conventional speed density system engine configuration is shown in FIG. 1. In a conventional speed density system, the speed density engine control module references three sensors to calculate the amount of air being ingested by the engine. The processor calculates the actual air mass entering the engine based on the input signals from the manifold air pressure sensor 20, the throttle position sensor 10 and the engine RPM sensor 40. The pulse width signal to the fuel injectors to provide the required air to fuel ratio for optimum engine performance is calculated by the processor using data tables inside the processor and the values from these sensors. In a programmable system, the data needs to be calculated and recalculated for any type of modification or improvement to the existing engine system. This can be very difficult and time consuming, requiring numerous alterations performed by one skilled in the art of engine tuning.

Although the above configuration can work well in certain circumstances, the programmable speed density system for fuel management systems can be challenging to implement for the average person or even a skilled technician. The optimum fuel to air mixture is obtained based on sensing throttle position, engine vacuum at the intake manifold as well as engine rpm. Input data is interpreted and the ideal fuel to air ratio is achieved based on sophisticated computer control. This requires, however, the expertise of a technician highly skilled in the art of engine tuning to program the controller to work optimally. This can be expensive and it is difficult to actually achieve optimal engine performance and efficiency using this method. Thus, there is a need for an improved way of furnishing a modern fuel management control system into vintage style engines and vintage replica engines to obtain performance while maintaining the vintage style look.

The vintage style look of an automobile internal combustion engine is created by having a traditional air filter assembly positioned over a vertically mounted throttle body which in turn is positioned over the air intake manifold. For purpose of clarity a vertically mounted throttle body shall be defined as any throttle body oriented so that air enters at the top of the throttle body and exits at the bottom of the throttle body.

The present invention provides an improved fuel management control system that incorporates a vintage style appearance.

An object of the invention is to furnish a modern fuel management control system for vintage style engines to increase performance while maintaining the vintage style look.

A further object of the invention is to furnish a modern fuel management control system for vintage replica engines to increase performance while maintaining the vintage style look.

Another object of the invention is to incorporate a mass air flow sensor below a traditional air filter assembly and on top of the vertically mounted throttle body to provide a vintage style appearance.

A still further object of the invention is to incorporate a mass air flow sensor inside of a traditional air filter assembly positioned on top of a vertically mounted throttle body to provide a vintage style appearance.

An additional object of the invention is to incorporate a mass air flow sensor as part of a traditional air filter assembly positioned on top of a vertically mounted throttle body to provide a vintage style appearance.

An additional object of the invention is to incorporate a mass air flow sensor as part of a vertically mounted throttle body below a traditional air filter assembly to provide a vintage style appearance.

### SUMMARY OF THE INVENTION

The present invention provides a modern performance fuel management system in conjunction with vintage style engine components and replica vintage style engine components while maintaining the vintage look. According to an aspect of the present invention, a method of manufacturing a high performance fuel management system for vintage engine components comprises of using a modern mass air flow sensor for fuel injection systems as in FIG. 2. In typical modern applications, the location of the mass air flow sensor is such that it is in plain sight. In the present invention the mass air flow sensor is hidden from view. This, in conjunction with vintage or vintage style components, results in a vintage appearance. The modern mass air flow sensor 30 can be mounted directly on top of a vertically mounted throttle body and below an air filter assembly, or in other locations that preserve the vintage appearance, as follows: the mass air flow sensor can be hidden inside a typical vintage style air filter assembly; the mass air flow sensor can be part of the air filter assembly; or the mass air flow sensor can be incorporated as a part of the vertically mounted throttle body. This is accomplished by manufacturing a mass air flow sensor, or modifying an existing mass air flow sensor, such that it is compact enough to be hidden from view by locating it in any one of the four locations described above. The mass air flow sensor directly measures the amount of air entering the engine. This dictates the delivery of fuel for the optimum fuel to air ratio. This is most preferred over speed density systems in that no programming is required by the user/installer. The direct measurement of air mass negates the need to calculate the effect of the various engine components as is necessary when using speed density control systems. As a result, the engine runs more efficiently, at the optimum settings, regardless of the various possible engine component combinations with no input from the user/installer. No programming is needed. Furthermore, the method of the present invention may render economical the addition of other functional benefits such as the ability to convert a signal from a frequency type mass air flow sensor into a voltage signal for use with such engine management systems that require a voltage signal. This aspect of the present invention allows for a more compact mass air flow sensor to be used with such engine controllers. Furthermore, the use of a modern mass air flow sensor in vintage engine systems allows for the ability to use existing modern mass air engine controllers from the major automobile manufacturers, allowing for possible compliance with today's emission standards.

The present invention encompasses incorporating a modern technology mass air flow sensor 30 into the componentry of a vintage looking fuel injection system or a replica of a vintage fuel injection system. The mass air flow sensor may be mounted on top of the vertically mounted throttle body and below a typical vintage style air filter assembly. The mass air flow sensor may be mounted inside a typical vintage style air filter assembly which, in turn, is mounted on top of the vertically mounted throttle body. Another variation would be to have the mass air flow sensor as an integral part of the vintage style air filter assembly which in turn is mounted on top of the vertically mounted throttle body. A fourth variation would be to to have the mass air flow sensor as an integral part of the vertically mounted throttle body with the typical vintage style air filter assembly mounted thereon.

The air to fuel ratio can be controlled directly with input from the mass air flow sensor thereby achieving optimum engine performance regardless of air intake manifold design and/or choice of engine componentry. The ratio of fuel to air is determined by actual measurements. There is a known value for the fuel to air ratio. The mass air flow sensor measures the actual amount of air flow, and the optimum amount of fuel is injected, thus eliminating the need for expensive, skill intensive, time consuming programming as required by speed density fuel management systems.

In order to obtain high performance (efficiency and power) a four barrel carburetor type air intake manifold is manufactured to receive fuel injectors, a vertically mounted throttle body is positioned above the air intake manifold, a mass air flow sensor is positioned above the vertically mounted throttle body and a traditional air filter assembly is positioned above the mass air flow sensor. Provided that the mass air flow sensor is receiving the air flow between the air filter assembly and the vertically mounted throttle body it would also be possible to position the mass air flow sensor in any one of the four locations described above. The resulting appearance is that of a vintage style engine.

In a modern automobile internal combustion engine, fuel is provided to the engine cylinders by means of a fuel injection system. The fuel injection system replaces the traditional carburetor. Modern automobiles often use mass air management systems, but they are far from vintage in appearance. The modern air filter is usually positioned separate from the engine and connected to the engine air intake manifold by means of a flexible duct. The modern air filter is usually encased in a housing that is difficult to recognize as an air filter. The mass air flow sensor is positioned visible somewhere in the duct.

In the present invention the vintage style look of an automobile internal combustion engine is created by having a traditional air filter assembly positioned over what appears to be a carburetor, which in turn is positioned over a vintage style air intake manifold. As discussed above this may be accomplished in at least four embodiments of the present invention, by positioning the mass air flow sensor in any one of the four described locations.

### BRIEF DESCRIPTION OF THE DRAWINGS

FIG. 1 is a sectional view of a conventional speed density system for fuel injection engine systems. Shown are the Throttle Position Sensor 10, Manifold Air Pressure Sensor (MAP) 20, RPM Sensor 40, Vertically Mounted Throttle Body 60, Vertically Mounted Throttle Body Intake End 61, Vertically Mounted Throttle Body Outlet 62, Air Intake Manifold 120, Air Intake Manifold Air Intake Flange 121, and Air Intake Manifold Plurality of Air Flow Outlets 122.

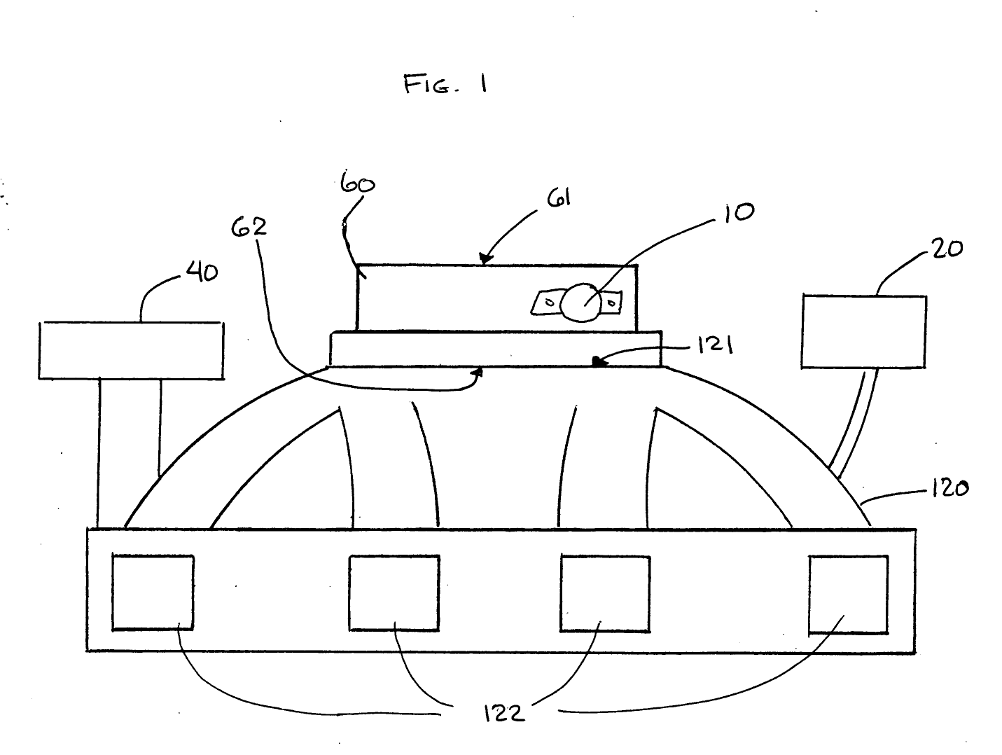

FIG. 2 is a sectional view of a Mass Air Engine Management System For Vintage Style Automobile Engines. In this configuration the Mass Air Flow Sensor 30 is mounted directly on top of the Vertically Mounted Throttle Body 60 and below the Air Filter Assembly 50. Shown are Throttle Position Sensor 10, RPM Sensor 40, Vertically Mounted Throttle Body 60, Vertically Mounted Throttle Body Intake End 61, Vertically Mounted Throttle Body Outlet End 62, Air Intake Manifold 120, Air Intake Manifold Air Intake Flange 121, and Air Intake Manifold Plurality of Air Flow Outlets 122. Also shown are Mass Air Flow Sensor 30, Mass Air Flow Sensor Intake End 31, Mass Air Flow Sensor Outlet End 32, Air Filter Assembly 50, and Air Filter Assembly Outlet End 51.

FIG. 3 is a sectional view of a Mass Air Engine Management System For Vintage Style Automobile Engines. In this configuration the Mass AirFlow Sensor 30 is mounted inside the AirFilter Assembly 50 which is positioned on top of the Vertically Mounted Throttle Body 60. Shown are Throttle Position Sensor 10, RPM Sensor 40, Vertically Mounted Throttle Body 60, Vertically Mounted Throttle Body Intake End 61, Vertically Mounted Throttle Body Outlet End 62, Air Intake Manifold 120, Air Intake Manifold Air Intake Flange 121, and Air Intake Manifold Plurality of Air Flow Outlets 122. Also shown are Mass Air Flow Sensor 30, Mass Air Flow Sensor Intake End 31, Mass Air Flow Sensor Outlet End 32, Air Filter Assembly 50, and Air Filter Assembly Outlet End 51.

FIG. 4 is a sectional view of a Mass Air Engine Management System For Vintage Style Automobile Engines. In this configuration the mass air flow sensor is a part of the air filter assembly. Shown are Throttle Position Sensor 10, RPM Sensor 40, Vertically Mounted Throttle Body 60, Vertically Mounted Throttle Body Intake End 61, Vertically Mounted Throttle Body Outlet End 62, Air Intake Manifold 120, Air Intake Manifold Air Intake Flange 121, and Air Intake Manifold Plurality of Air Flow Outlets 122. Also shown are Combined Air Filter And Mass Air Flow Sensor 70, Combined Air Filter And Mass Air Flow Sensor Outlet End 71.

FIG. 5 is a sectional view of a Mass Air Engine Management System For Vintage Style Automobile Engines. In this configuration the mass air flow sensor is part of the vertically mounted throttle body. Shown are Throttle Position Sensor 10, RPM Sensor 40, Air Intake Manifold 120, Air Intake Manifold Air Intake Flange 121, and Air Intake Manifold Plurality of Air Flow Outlets 122. Also shown are Combined Vertically Mounted Throttle Body And Mass Air Flow Sensor 80, Combined Vertically Mounted Throttle Body And Mass Air Flow Sensor Intake End 81, Combined Vertically Mounted Throttle Body And Mass Air Flow Sensor Outlet End 82, Air Filter Assembly 50, and Air Filter Assembly Outlet End 51.

FIG. 6 is a sectional view of a Mass Air Engine Management System For Vintage Style Automobile Engines. Shown are, Vertically Mounted Throttle Body 60, Vertically Mounted Throttle Body Intake End 61, Vertically Mounted Throttle Body Outlet End 62, Air Intake Manifold 120, Air Intake Manifold Air Intake Flange 121, and Air Intake Manifold Plurality of Air Flow Outlets 122. Also shown are Mass Air Flow Sensor That Outputs A Frequency Signal 33, Frequency To Voltage Converter 130, Engine Control Module That Reads Voltage Input 140, Air Filter Assembly 50, and Air Filter Assembly Outlet End 51.

### DESCRIPTION OF THE PREFERRED EMBODIMENT

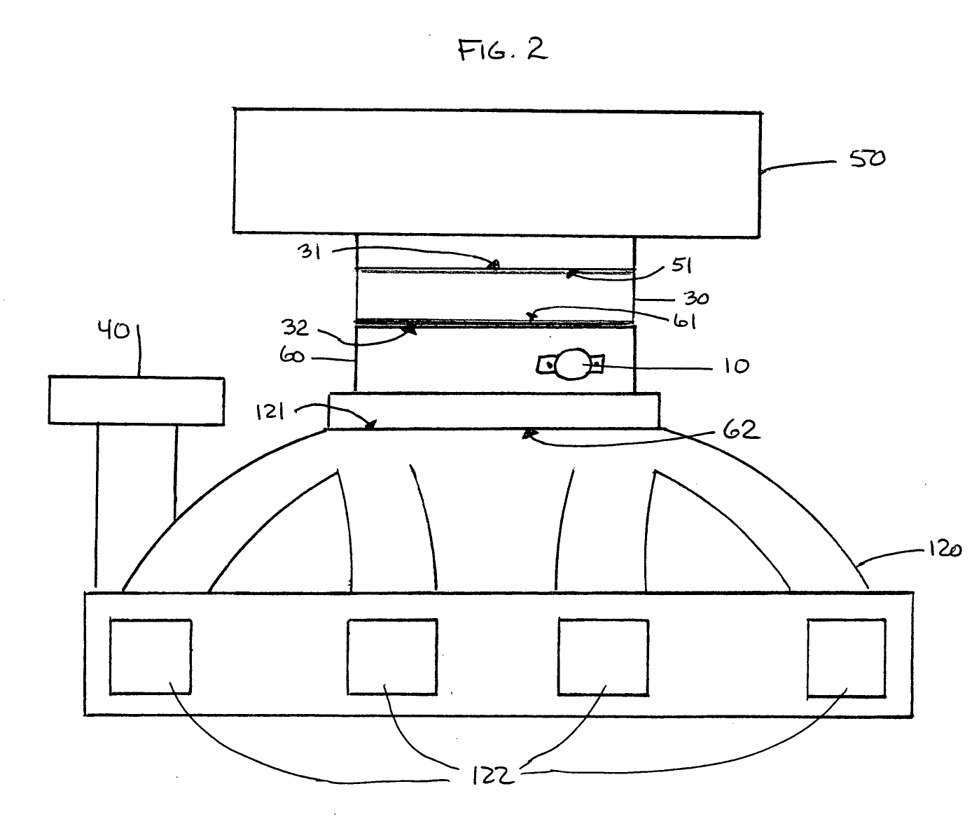

Referring now to the drawings and the illustrative embodiments depicted therein, a mass air flow sensor 30, in accordance with the present invention, is shown in FIG. 2.

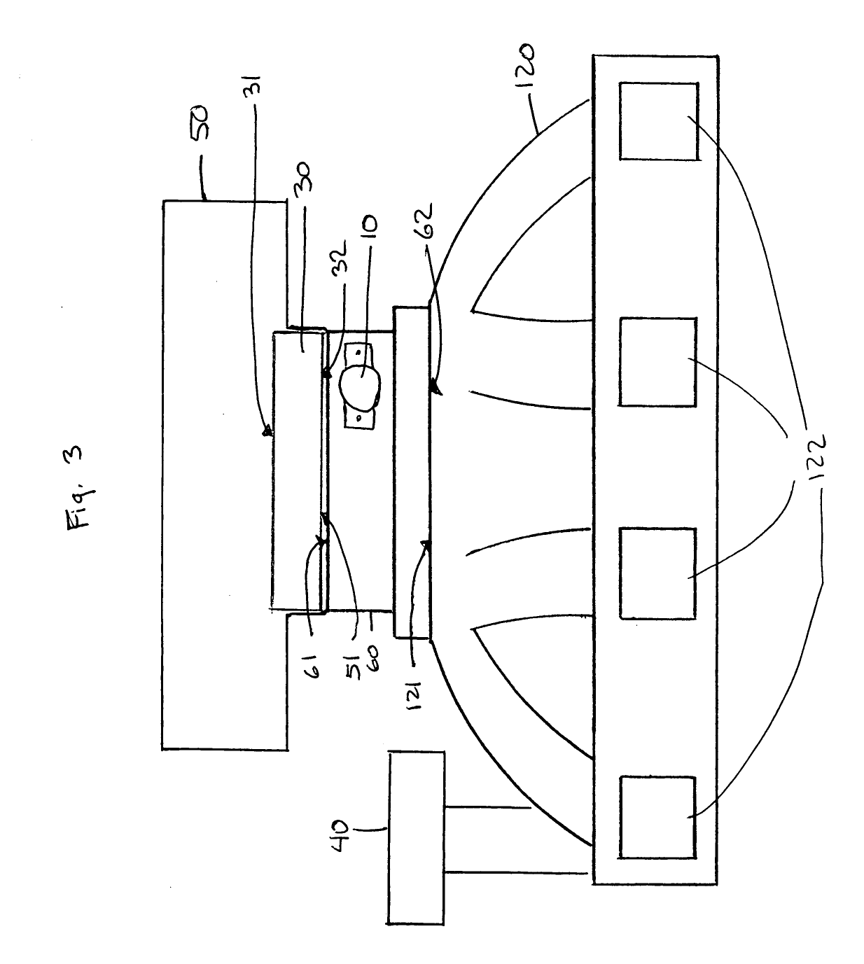

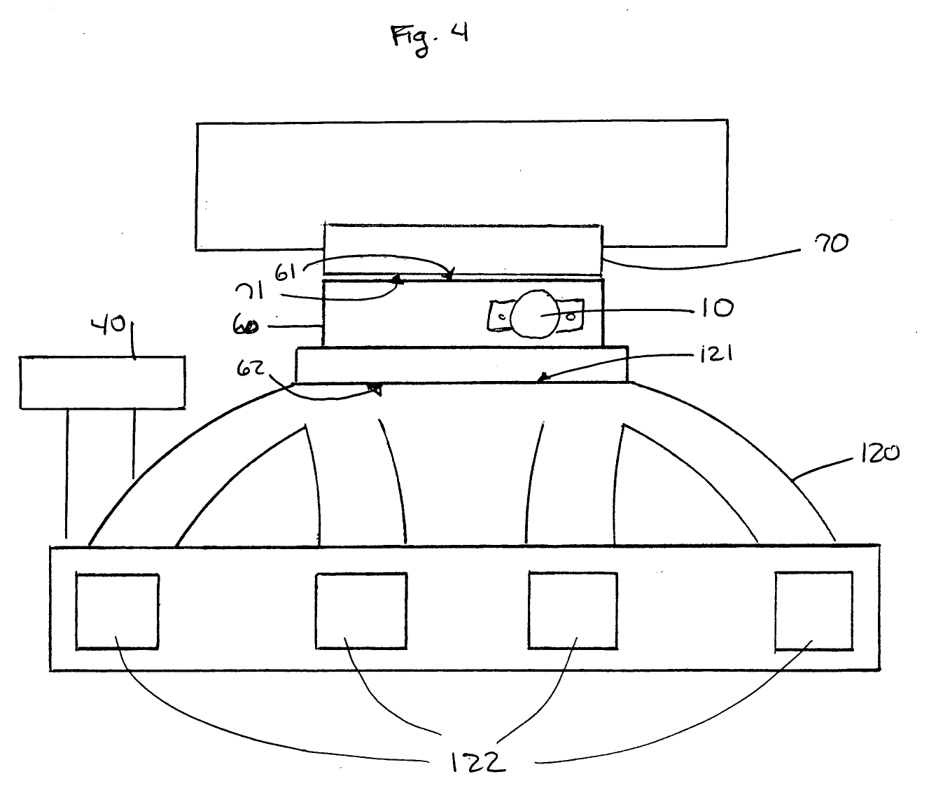

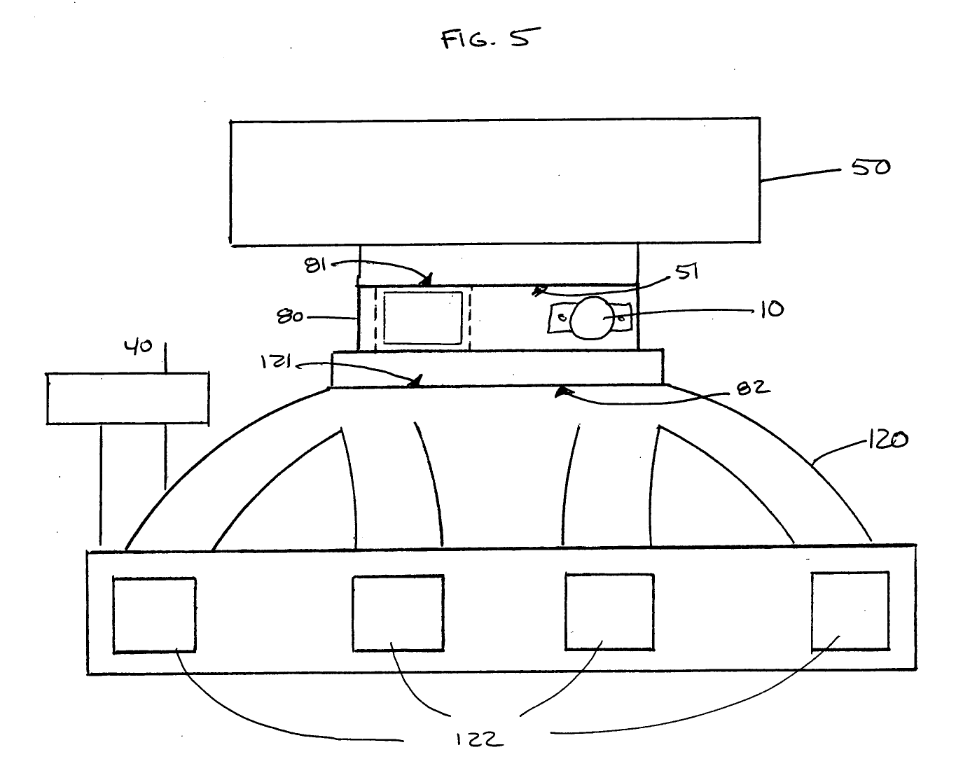

The present invention thus provides a high performance fuel management system for vintage style engine components and replica vintage style engine components while maintaining the vintage look. The system comprises of using a modern mass air flow sensor 30, for fuel injection systems as in FIG. 2 by mounting the mass air flow sensor 30, below an air filter assembly 50, and above the vertically mounted throttle body 60. The system may be varied by positioning the mass air flow sensor 30, within an air filter assembly 50, and still above the vertically mounted throttle body 60 as shown in FIG. 3. Another variation is to incorporate the mass air flow sensor, as an integral part of the air filter assembly, with the combined air filter and mass air flow sensor 70, positioned above the vertically mounted throttle body 60, as shown in FIG. 4. A further variation is to size and shape the mass air flow sensor, in order that it is an integral part of the vertically mounted throttle body with the combined vertically mounted throttle body and mass air flow sensor 80 positioned below an air filter assembly 50 as shown in FIG. 5. The mass air flow sensor directly measures the amount of air entering the engine dictating the delivery of fuel to the engine for the optimum fuel to air ratio. Therefore the optimum engine performance is accomplished with no input from the user/installer while maintaining the vintage engine look.

Changes and modifications in the specifically described embodiments may be carried out without departing from the principles of the present invention.

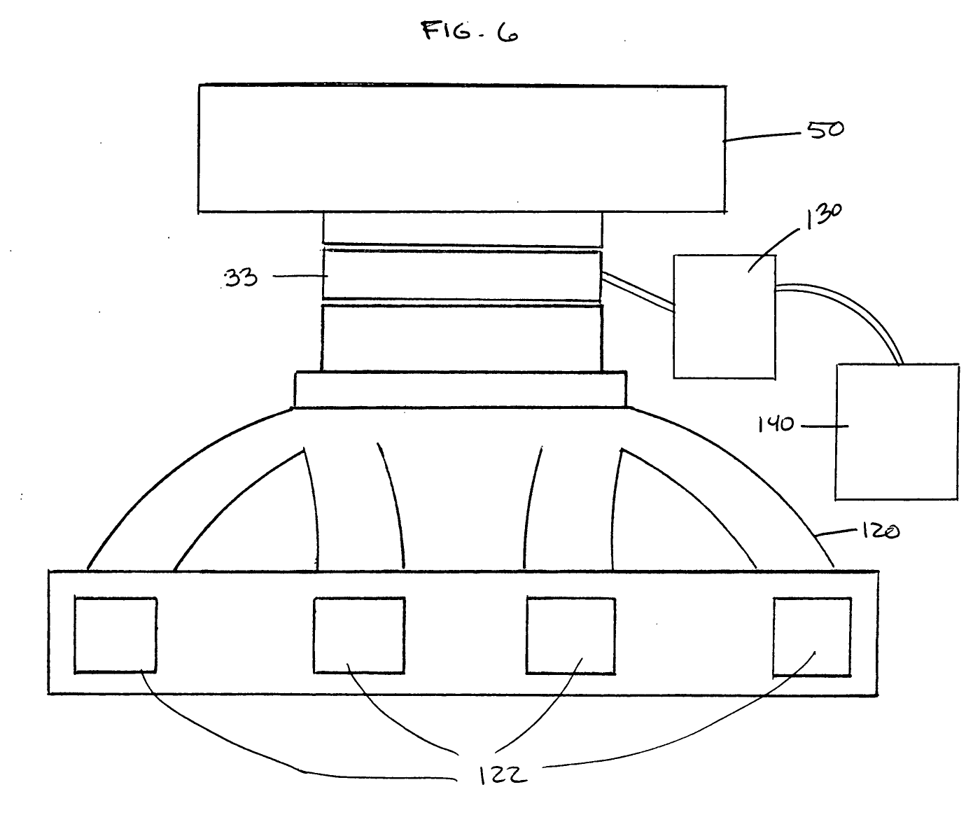

The present invention provides a modern performance fuel management system in conjunction with vintage style engine components and replica vintage style engine components while maintaining the vintage look. According to an aspect of the present invention, a high performance fuel management system for vintage engine components comprises of using a modern mass air flow sensor 30, for fuel injection systems as in FIG. 2. In typical modern applications, the location of the mass air flow sensor is such that it is in plain sight. In the present invention the mass air flow sensor 30, is hidden from view. This, in conjunction with vintage or vintage style components, results in a vintage appearance. The modern mass air flow sensor 30 can be mounted directly on top of a vertically mounted throttle body 60, and below an air filter assembly 50, as shown in FIG. 2 or in other locations that preserve the vintage appearance, as follows: the mass air flow sensor 30, can be hidden inside a typical vintage style air filter assembly 50, as shown in FIG. 3; the mass air flow sensor can be part of the air filter assembly as shown in FIG. 4 as the combined air filter and mass air flow sensor 70; or the mass air flow sensor can be incorporated as a part of the vertically mounted throttle body as shown in FIG. 5 as combined vertically mounted throttle body and mass air flow sensor 80. This is accomplished by manufacturing a mass air flow sensor that is compact enough to be hidden from view by locating it in any one of the four locations described above. The mass air flow sensor directly measures the amount of air entering the engine. This dictates the delivery of fuel for the optimum fuel to air ratio. This is most preferred over speed density systems in that no programming is required by the user/installer. The direct measurement of air mass negates the need to calculate the effect of the various engine components as is necessary when using speed density control systems. As a result, the engine runs more efficiently, at the optimum settings, regardless of the various possible engine component combinations with no input from the end user/installer. No programming is necessary. Furthermore, the method of the present invention may render economical the addition of other functional benefits such as the ability to convert a signal from a frequency type mass air flow sensor 90, into a voltage signal by means of a frequency to voltage converter 100, for use with an engine control module 110 that requires an voltage signal, as shown in FIG. 6. This aspect of the present invention allows for a more compact mass air flow sensor to be used with such engine controllers. Furthermore, the use of a modern mass air flow sensor in vintage engine systems allows for the ability to use existing modern mass air engine control modules from the major automobile manufacturers, allowing for possible compliance with today's emission standards.

The present invention encompasses incorporating a modern technology mass air flow sensor 30 into the componentry of a vintage looking fuel injection system or a replica of a vintage fuel injection system. The mass air flow sensor 30 may be mounted on top of the vertically mounted throttle body 60 and below a typical vintage style air filter assembly 50. The mass air flow sensor 30 may be mounted inside a typical vintage style air filter assembly 50 which, in turn, is mounted on top of the vertically mounted throttle body 60. Another variation would be to have the mass air flow sensor as an integral part of the vintage style air filter assembly with the resulting combined air filter and mass air flow sensor 70 which in turn is mounted on top of the vertically mounted throttle body 60. A fourth variation would be to have the mass air flow sensor as an integral part of the vertically mounted throttle body with the resulting combined vertically mounted throttle body and mass air flow sensor 80 positioned below the typical vintage style air filter assembly 50.

The air to fuel ratio can be controlled directly with input from the mass air flow sensor thereby achieving optimum engine performance regardless of air intake manifold design and/or choice of engine componentry with no programming necessary. The ratio of fuel to air is determined by actual measurements. There is a known value for the fuel to air ratio. The mass air flow sensor measures the actual amount of air flow, and the optimum amount of fuel is injected, thus eliminating the need for expensive, skill intensive, time consuming programming as required by speed density fuel management systems.

In order to obtain high performance (efficiency and power) a four barrel carburetor type air intake manifold 120 is manufactured to receive fuel injectors, a vertically mounted throttle body 60 is positioned above the air intake manifold 120, a mass air flow sensor 30 is positioned above the vertically mounted throttle body 60 and a traditional air filter assembly 50 is positioned above the mass air flow sensor 30, as shown in FIG. 2. Provided that the mass air flow sensor is receiving the air flow between the air filter assembly and the vertically mounted throttle body it would also be possible to position the mass air flow sensor in any of the four locations listed above. The resulting appearance in all configurations is that of a vintage style engine.

In a modern automobile internal combustion engine, fuel is provided to the engine cylinders by means of a fuel injection system. The fuel injection system replaces the traditional carburetor. Modern automobiles often use mass air management systems, but they are far from vintage in appearance. The modern air filter is usually positioned separate from the engine and connected to the engine air intake manifold by means of a flexible duct. The modern air filter is usually encased in a housing that is difficult to recognize as an air filter. The mass air flow sensor is positioned visible somewhere in the duct.

In the present invention the vintage style look of an automobile internal combustion engine is created by having a traditional air filter assembly positioned over what appears to be a carburetor, which in turn is positioned over a vintage style air intake manifold. As discussed above this may be accomplished in at least four embodiments of the present invention, by positioning the mass air flow sensor in any one of the four described locations.

What is claimed is:

1. A modern mass air engine management system, for use with an internal combustion engine, with an air intake system that has a vintage appearance comprising:
a. an air intake manifold with air inlet flange and a plurality of air flow outlets;
b. a vertically mounted throttle body with an intake end and an outlet end, said outlet end being sized and shaped to connect to the air intake manifold inlet flange;
c. a mass air flow sensor with an intake end and an outlet end said outlet end being sized and shaped to connect to the vertically mounted throttle body intake end; and
d. an air filter assembly with an outlet end, said outlet end being sized and shaped to connect to the mass air flow sensor intake end.

2. A modern mass air engine management system, for use with an internal combustion engine, with an air intake system, as described in claim 1 above further comprising:
a. a mass air flow sensor that outputs a frequency signal, and includes:
i. a frequency to voltage converter; and
ii. an engine control module that reads voltage input.

3. A modern mass air engine management system, for use with an internal combustion engine, with an air intake system that has a vintage appearance comprising:
a. an air intake manifold with air inlet flange and a plurality of air flow outlets;
b. a vertically mounted throttle body with an intake end and an outlet end, said outlet end being sized and shaped to connect to the air intake manifold inlet flange;
c. a mass air flow sensor with an intake end and an outlet end said outlet end having an internal surface and an outward surface said internal surface being sized and shaped to connect to the vertically mounted throttle body intake end; and
d. an air filter assembly with an outlet end, said outlet end being sized and shaped to accommodate the outward surface of the outlet end of the mass air flow sensor and further said air filter assembly having an internal chamber sized and shaped to receive said mass air flow sensor.

4. A modern mass air engine management system, for use with an internal combustion engine, with an air intake system, as described in claim 3 above further comprising:
a. a mass air flow sensor that outputs a frequency signal, and includes:
i. a frequency to voltage converter; and
ii. an engine control module that reads voltage input.

5. A modern mass air engine management system, for use with an internal combustion engine, with an air intake system that has a vintage appearance comprising:
a. an air intake manifold with air inlet flange and a plurality of air flow outlets;
b. a vertically mounted throttle body with an intake end and an outlet end, said outlet end being sized and shaped to connect to the air intake manifold inlet flange; and
c. a combined air filter and mass air flow sensor assembly with an outlet end said outlet end being sized and shaped to connect to the vertically mounted throttle body intake end.

6. A modern mass air engine management system, for use with an internal combustion engine, with an air intake system, as described in claim 5 above further comprising:
a. a mass air flow sensor that outputs a frequency signal, and includes:
i. a frequency to voltage converter; and
ii. an engine control module that reads voltage input.

7. A modern mass air engine management system, for use with an internal combustion engine, with an air intake system that has a vintage appearance comprising:
a. an air intake manifold with air inlet flange and a plurality of air flow outlets;
b. a combined vertically mounted throttle body and mass air flow sensor with an intake end and an outlet end, said outlet end being sized and shaped to connect to the air intake manifold inlet flange;
c. an air filter assembly with an outlet end, said outlet end being sized and shaped to connect to the combined vertically mounted throttle body and mass air flow sensor intake end.

8. A modern mass air engine management system, for use with an internal combustion engine, with an air intake system, as described in claim 7 above further comprising:
a. a mass air flow sensor that outputs a frequency signal, and includes:
i. a frequency to voltage converter; and
ii. an engine control module that reads voltage input.
